(19) United States
(12) Patent Application Publication
(10) Pub. No.: US 2004/0267559 A1
(43) Pub. Date: Dec. 30, 2004

(54) Dispute management system and method

(76) Inventors: Hans Harald Hinderer, Heidelberg (DE); Kai Schwiebert, Karlsruhe (DE); Philipp Kehrer, Heidelberg (DE); Dietmar Engelmann, Sinsheim (DE); Martin Molz, Wiesloch (DE); Dirk Scheller, Walldorf (DE); Volker Schnuck, Muenster (DE); Stephan Wilhelm, Dielheim (DE)

Correspondence Address: KENYON & KENYON, 1500 K STREET, N.W., SUITE 700, WASHINGTON, DC, 20005, US

(21) Appl. No.: 10/739,267

(22) Filed: Dec. 19, 2003

Related U.S. Application Data
(60) Provisional application No. 60/444,308, filed on Jan. 31, 2003.

(51) Int. Cl. G06F 17/60

(52) U.S. Cl. 705/1

(57) ABSTRACT

A dispute management system and method for managing the process of resolving disputes relating to billing for goods or services. The dispute management system may comprise a dispute case creator for creating a dispute case that organizes information relating to a dispute, an inbox making the dispute case available to a customer care employee and a dispute case object. The dispute management system may be connected to accounting systems through a financial interaction center so it may retrieve information relating to a dispute and make changes needed in the accounting systems when the dispute is resolved.

### CROSS REFERENCE TO RELATED APPLICATIONS

This application claims the benefit under 35 U.S.C. § 119(e) of U.S. Provisional Application No. 60/444,308, filed Jan. 31, 2003.

### BACKGROUND OF THE INVENTION

Billing disputes are common occurrences. These disputes can negatively affect a business' cash flow and customer relations. When a dispute arises, a customer may well delay paying bills while the billing party investigates the disputed claim. The resolution of a dispute case can require involvement of several departments to investigate reasons for dispute. Additionally, delays or errors in resolving the dispute can cause major customer relations problems. Customers may become irritated enough at the billing party to move their business to competitors of the billing party.

Thus, a need exists for a system and method of managing the dispute resolution process that speeds up the process and enhances its accuracy.

### SUMMARY OF THE INVENTION

The present invention relates to a dispute management system and method for managing the investigation and resolution of disputes regarding billing between a customer and a goods and/or services provider. A dispute management system and method according to the present invention may interact with front-line customer care employees and back-office customer care employees to smoothly handle customer-billing disputes in a telecommunications service industry, for example. The system may provide a dispute case creator for creating a dispute case related to a dispute, an inbox for making the dispute case available for further work, a search capability for finding and retrieving information relating to an account and an outgoing communication creator for creating an outgoing communication for a customer relating to a dispute in a telecommunications service industry

The present invention has advantages over the prior art. It speeds up the dispute management process by automating many portions of the process and organizing information related to a dispute. Through such automation and organization, the present invention enables the implementation of standardized processes and also increases the accuracy of the process.

An embodiment of the present invention provides a system and method for managing a dispute resolution process.

Another embodiment of the present invention provides for the capture of information relating to a dispute into a dispute case.

Another embodiment of the present invention provides for the managing of dispute cases through an inbox.

Another embodiment of the present invention provides for the affecting of information within an accounting system such as an accounts receivable system and/or a billing system based upon the results of a resolution of a dispute.

Another embodiment of the present invention provides for the organizing of information relating to a dispute, such as the disputed invoice, customer contact information, and accounting items such as debits and payments into a dispute case.

Another embodiment of the present invention provides for an organized manner of making a dispute case available for work through an inbox.

Another embodiment of the present invention provides for permitting results of a resolution of a dispute to affect information within an accounting system.

### BRIEF DESCRIPTION OF THE DRAWINGS

FIG. 1 is a block diagram of a dispute management system according to an embodiment of the present invention.

FIG. 2 is a flow chart depicting a process for handling a dispute utilizing a dispute management system according to an embodiment of the present invention.

FIG. 3 is a flow chart depicting a process for handling a dispute utilizing a dispute management system according to an embodiment of the present invention.

### DETAILED DESCRIPTION

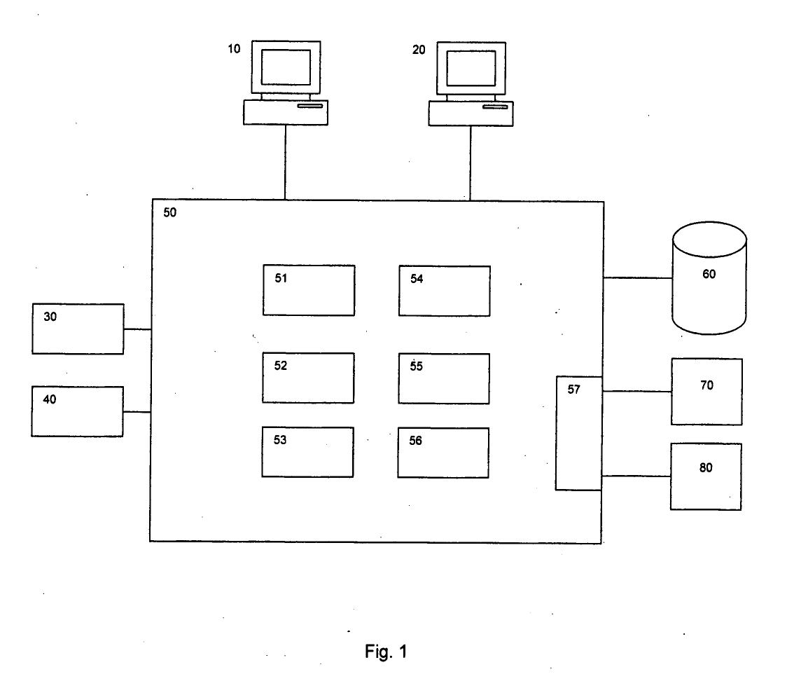

Referring now to FIG. 1, a dispute management system according to an embodiment of the present invention is shown. Dispute management system 50 can be accessed by front-line customer care employee 10 and back-office customer care employee 20. It contains various functionality and provides access to external systems so as to enable front-line customer care employee 10 and back-office customer care employee 20 to better handle billing disputes with customers.

Dispute management system 50 communicates with database 60. It also communicates with accounting systems 70 and 80, such as an accounts receivable system and a billing system. Financial interaction center 57 is provided to interface with accounting systems 70 and 80. It makes information contained within those systems available to employees using dispute management system 50 and permits such employees to make changes (such as a write-off, credit, or splitting of an invoice into disputed items and undisputed items) while on dispute management system 50. Dispute management system 50 may of course communicate with other accounting systems and databases as needed.

Dispute management system 50 may also provide access to scripts 30 that may be used by front-line customer care employee 10 when dealing directly with customers. It also may provide access to an electronic scratch pad 40. Electronic scratch pad 40 permits front-line customer care employee 10 and/or back-office customer care employee 20 to take notes relating to a specific customer or dispute during a communication. Alternatively, scripts 30 and electronic scratch pad 40 may be provided directly by dispute management system 50.

Dispute management system 50 contains dispute case object 51. This object contains all relevant information of a dispute case. Preferably, dispute case object 51 has a few key describing attributes, is like a folder in that it links all relevant documents and objects, can be processed across multiple departments and employees and supports multiple interaction channels. Some examples of possible attributes for dispute case object 51 include dates, description, notes and history, status, reason code, type and category, priority, employees responsible, and dispute amounts. Dispute case object 51 also provides action log and note taking capabilities (which may involve scratch pad 40) so as to permit employees working on the dispute case to capture work they have done on the case and any changes or additions to the case. Alternatively, this functionality can be accomplished using non-object-oriented programming.

Dispute management system 50 also contains dispute case processor 52. This functionality enables multiple employees and organizational units to work on the same dispute case. The determination of the identity or the assigned employee can be done automatically (based on attributes, for example) or manually. Dispute management system 50 further has search functionality 53 for searching through database 60, information stored in accounts receivable system 70, and/or information stored in billing system 80, and for retrieving and displaying search results.

Dispute case creator 54 is provided for the creation of dispute cases, including the capture of important information relating to the case. The use of the term “capture” herein is not intended to be limited to actually gathering information into a single location, but may include other methods of organizing information, such as linking it. Dispute case creator 54 supports the manual creation of dispute cases by employees and by customers (over the Internet, for example) and the automatic creation of dispute cases through interaction with accounting systems 70 and/or 80, such as when there is an underpayment of a bill. An inbox 55 is provided to hold open dispute cases and present them to employees who may be working on the cases. Follow-up action trigger 56 is provided for automatically triggering events and actions. Such actions could include sending an outgoing communication, creating credit notes, or writing off receivables in accounts receivable system 70, for example.

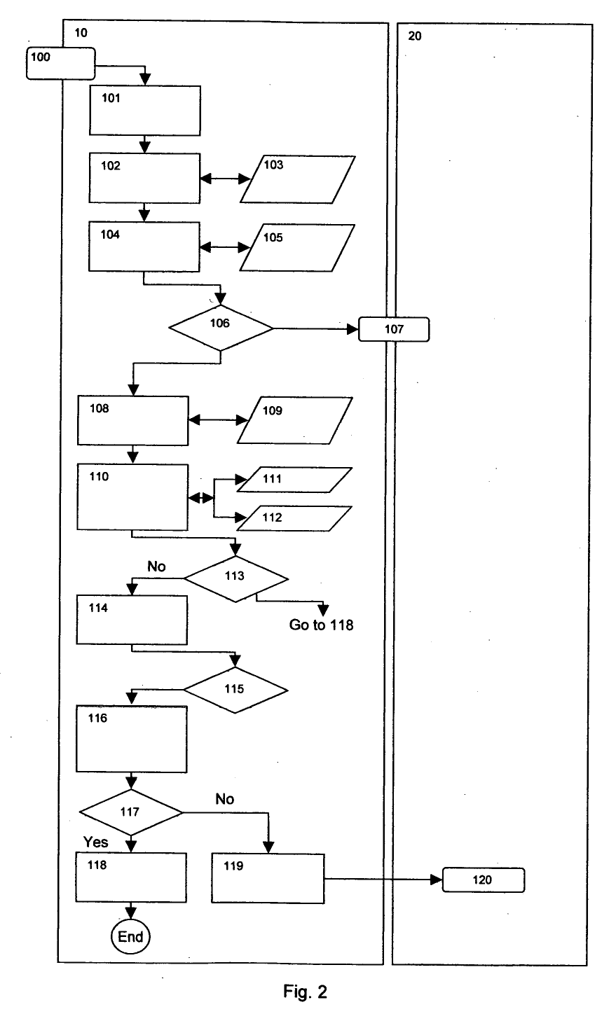

Dispute management system 50 and its components are better understood through a discussion of their use in the process of managing a dispute. Referring now to FIG. 2, a process of dispute management according to an embodiment of the present invention is shown. Certain of the steps of the process occur with input from a front-line customer care employee 10 who deals directly with the customer when the customer first contacts the customer care department. Other steps occur with input from a back-office customer care employee 20.

In step 100, a customer initiates a contact with front-line customer care employee 10. Typically, this contact is a phone call. However, it may be in another form such as an email, instant message, facsimile, etc.

In step 101, front-line customer care employee 10 receives the contact from the customer. Front-line customer care employee 10 then determines the reason for the contact. This can be done by, for example, simply issuing a greeting and asking why the customer initiated the contact. In this step, scratch pad 40 and/or a script 30 may be made available to front-line customer care employee 10 by the dispute management system 50. Multiple scripts 30 could even be made available so as to present a choice for front-line customer care employee 10 based upon the situation, such as the problem, value of the customer or customer complaint history, for example. If the customer is identified by ANI (or some other means based upon the information contained in the contact itself), search functionality 53 may find the customer information automatically. Otherwise, front-line customer care employee may ask the customer for information regarding his identity.

In step 102, customer identification and verification is performed. This may include a search by search functionality 53 in database 60, and/or accounting systems 70 and 80, for customer information, such as phone number, account number, etc., as shown in step 103. Front-line customer care employee 10 may verify the customer identification by asking a predetermined question, such as the customer's mother's maiden name, an identification number, etc.

In step 104, a customer overview is displayed to front-line customer care employee 10 by search functionality 53. This may include a look-up in database 60, and/or accounting systems 70 and/or 80, for information such as case history, credit status, account status, any contracts, etc., as shown in step 105. Front-line customer care employee 10 may then review the displayed data to gain some understanding of the customer. If it is a corporate customer or a customer with multiple accounts, the particular account being disputed can be selected by either narrowing a search or choosing among the resulting accounts by clicking on the appropriate one. Dispute management system 50 can here display defined information to front-line customer care employee 10 and alert them about important information, such as a disconnection of service to the customer, the value of the customer, etc.

In step 106, if the reason for the call is that the customer does not understand a charge in the invoice, the process moves on to step 108. For instance, the customer may not understand why a charge exists, such as a dunning or late payment fee. If it is for another reason, it moves on to step 107 where other processes are undertaken.

In step 108, the invoice is found. Search functionality 53 may perform a look-up in database 60, and/or accounting systems 70 and/or 80, by using invoice number, date, account number, phone number, etc., as shown in step 109. A list of invoices may be displayed by the system permitting front-line customer care employee 10 to select the appropriate invoice. Front-line customer care employee 10 may obtain information from the customer such as the invoice number, the date of the invoice, the total amount of the bill, or the like, in order to particularly identify the appropriate invoice. Links can be provided to call an image of the invoice from database 60, and/or accounting systems 70 and/or 80.

In step 110, the invoice is displayed. Front-line customer care employee 10 then determines the exact dispute reason from the invoice and offers an explanation to the customer. This may include a look-up to obtain the invoice from database 60 or other system in step 111 and an interaction with a knowledge management system in step 112.

In step 113, it is determined if the customer is satisfied or not. If the customer is satisfied, the process goes to step 118. If the customer is not satisfied, it proceeds to step 114.

In step 114, the dispute case is captured through dispute case creator 54. Dispute case creator 54 presents front-line customer care employee 10 with a menu of choices. For instance, front-line customer care employee 10 may click on case management and on “dispute” under case-type. The reason for the dispute and the category or type of the dispute can be selected. The data for the dispute case is captured by dispute case creator 54, such as the disputed amount and the bill number. Notes can also be captured for the case, from scratch pad 40, for instance. The documents, for instance the bill and dunning letter, and objects, such as the contract account, that should be captured by the dispute case can be selected. This can be done by the system displaying a selectable list of objects and documents that front-line customer care employee 10 has opened.

In step 15, the dispute type is determined. In step 16, the invoice, payment, dunning letter, and dispute case history (which can be displayed as a case list, for example) are then reviewed by front-line customer care employee 10. For example, if the customer is disputing a dunning fee, front-line customer care employee 10 can review the information to determine if the bill was paid before the dunning letter was sent, or if it was likely paid after the dunning letter was received, or if it was likely that the dunning letter and payment crossed in the mail. It is then explained to the customer by front-line customer care employee 10. In step 117, it is again determined if the customer is satisfied. If the customer is satisfied, in step 118 any wrap-up actions are performed, such as capturing final information about the agreement for the case by dispute case creation functionality 54 and the case is closed. This action may include capturing notes prepared on scratch pad 40 and storing the closed case in database 60, for example. Dispute case creator 54 could warn front-line customer care employee 10 if all the mandatory fields are not filled in. Front-line customer care employee 10 can then end the contact with the customer. Dispute management system 50 can go into a wait mode to await the next call.

If the customer is not satisfied, in step 119, wrap-up actions are performed. These actions include the capture of some of the information about the dispute by dispute case creator 54. Front-line customer care employee 10 can direct the case to a particular back-office customer care employee 20, department or other organizational unit, or just add it to a queue. Front-line customer care employee 10 may capture the phone number of the customer to forward to back-office customer care employee 20 handling the case to assist him to contact the customer. Other information could be gathered from the customer as well. Dispute management system 50 may show a filtered list of back-office customer care employees, such as based on the reason for the case category. Dispute management system 50 can also warn if mandatory fields are not filled in. The system can go back to a wait mode to await the next call. The case is sent to inbox 55 for further processing in step 120.

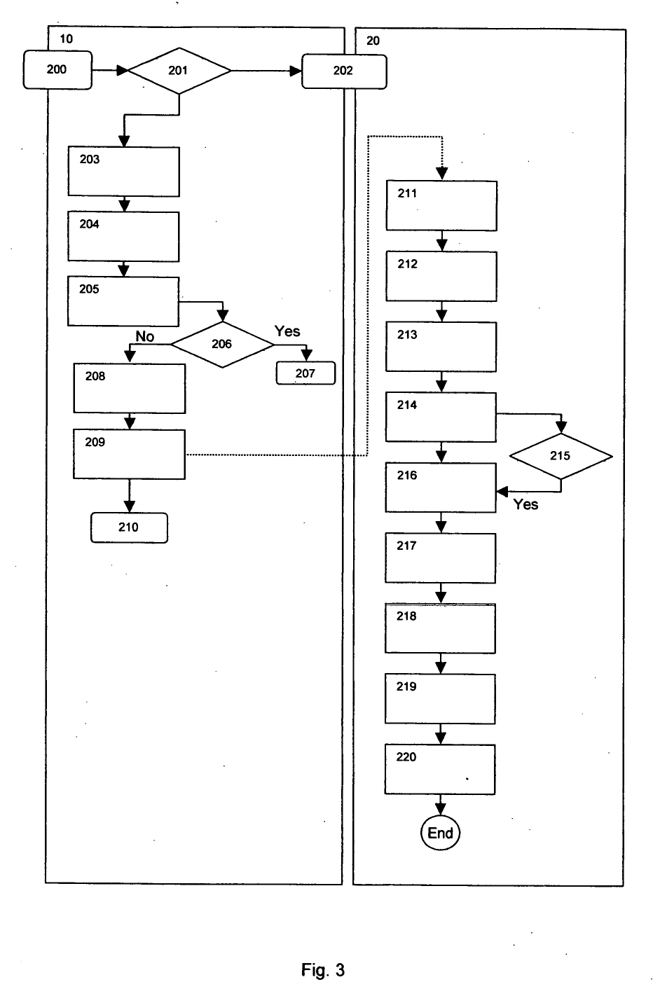

Referring now to FIG. 3, in step 200, a customer contact is received. A greeting and identification of the customer is also performed, much as in steps 101-105 in the embodiment of FIG. 2. In step 201, the reason for the contact is determined. If the reason is relating to the customer receiving a dunning letter although he has already paid, the process moves to step 203. If not, it moves on to other processes in step 202.

In step 203, the dunning letter is found. This step may include a look-up in database 60, and/or accounting systems 70 and/or 80, by search functionality 53. This search functionality should be capable of finding the dunning notice through an invoice number, invoice date, etc. Search functionality 53 can provide a list of latest dunning notices and enable front-line customer care employee 10 to select the link to display the appropriate notice.

In step 204, the account balance is determined. Dispute management system 50 provides front-line customer care employee 10 with ability to open a window from an accounting system 70 and/or 80 to display information regarding the customer's account, such as what amount is open, what is due, etc.

In step 205, payment and invoicing history is checked. Search functionality 53 displays the account overview and history for the customer. This may also include a look-up in database 60 and/or accounting systems 70 and/or 80. Front-line customer care employee 10 drills down to see if the invoice of the dunning notice is still open or if a payment is posted. It permits him to look for payments that might have not been posted to the correct invoice. Front-line customer care employee 10 may ask for additional information from customer, such as method of payment, check number, credit card number, date of payment, etc., to assist him in looking for the disputed payment.

In step 206, it is determined if a payment is found. If the payment is found, other processes are undertaken in step 207. Such processes may include reversing the dunning notice as described hereinafter with respect to steps 216 and 217.

If a payment is not found, in step 208, a dispute case is captured by dispute case creator 54 and the customer's payment data is taken. Dispute case creator 54 captures information about the dispute including information about the payment, such as method of payment, date of payment, check number, credit card number, etc. Front-line customer care employee 10 can then block further dunning for the disputed item and indicate that payment by the customer for the disputed item is doubtful. The disputed item can be split from undisputed items so that the undisputed items can be billed without the risk that the dispute will jeopardize prompt payment for undisputed items. Dispute case creator 54 permits front-line customer care employee 10 to capture the phone number where customer can be reached or to enter other such information that will aid back-office customer care employee 20 in contacting him once a payment is found.

In step 209, necessary wrap-up measures are taken and the case is moved to inbox 55 for back-office processing to step 211. In step 210, the contact with the customer is ended.

In step 211, the disputed case is received by a back-office customer care employee 20 through inbox 55. Dispute management system 50 may provide one single view and one single portal to both customer care employee 10 and back-office customer care employee 20. Case management inbox 55 permits back-office customer care employee 20 to select a particular case from a list of incoming disputed cases. Once selected, it can be specifically assigned to a particular back-office customer employee if desired. Alternatively, assignments can be made automatically. Inbox 55 permits filtering of the cases for a particular employee so that a particular employee would only see cases assigned to him. It also provides sorting capabilities, by date, or type, for instance.

In step 212, back-office customer care employee 20 reviews the dispute case history. Dispute management system 50 permits viewing of the notes that had been captured by front-line customer care employee 10.

In step 213, the payment history can also be viewed. The system so permits back-office customer care employee 20 to review open items and payment history including all incoming payments to permit matching of a payment to the disputed invoice. It allows drill down in the account on an item level to see bills and payments.

In step 214, a search is undertaken for a payment utilizing search functionality 53. This can be a more in-depth search than that performed by front-line customer care employee 10. If more information is needed to find the payment, back-office customer care employee 20 may contact the customer to get additional information.

In step 215, it is determined if a payment is found. If it is, then in step 216, the payment is allocated to the open item. Dispute management system 50 permits interaction with accounting systems 70 and/or 80, in order to facilitate the allocation of the payment to the correct bill or open item. Dispute management system 50 should therefore provide a list of open items of the customer and permit the allocation of the payment to the open item, thereby closing it.

In step 217, the dunning fee is then reversed. Dispute management system 50 permits the dunning fee to be reversed through interaction with accounting systems 70 and/or 80 through capturing it in an accounts receivable system or by creating a credit in a billing system, for example.

In step 218, the dispute case logging is updated. Dispute case creator 54 captures the results of the investigation and actions taken by back-office customer care employee 20. This can be accomplished through case management notes on scratch pad 40, for example, or can be automated.

In step 219, confirmation of the receipt of payment is sent to the customer. Outgoing communication creator 56 sends an acknowledgement to the customer that the dispute has been resolved. This can be accomplished through email, letter, facsimile, call, or other method. The method of the communications may be selectable by back-office customer care employee 20 or predetermined. Additional information can be captured if desired to further explain the results, such as an explanation of why the payment had not been posted correctly. Outgoing communication creator 56 permits the communication to be created through the selection of standard text (sentences, paragraphs or entire communications) templates with the provision of the ability to permit editing by back-office customer care employee 20. It then can capture the address and/or any other necessary information and the selected template(s) and any changes and print off the letter if a letter option is selected, for example.

In step 220, the disputed case is closed and the process ends.

As mentioned before, the dispute management system of the present invention can also be used in such a fashion that dispute case creator 54 automatically would create a dispute case and place it within inbox 55 when accounting systems 70 and/or 80 show an underpayment by a customer or permit a customer to manually create a dispute case.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A dispute management system for managing a billing dispute with a customer and being capable of communicating with accounting systems, such as an accounts receivable system or a billing system, said dispute management system comprising:
a dispute case creator, said dispute case creator providing for the creation of a dispute case by providing for the capturing of information relating to said dispute case;
an inbox, said inbox presenting said dispute case to a person for further action.

2. A dispute management system as in claim 1, further comprising a search capability, said search capability being designed to search for accounting information.

3. A dispute management system as in claim 1, further comprising a dispute case object, said dispute case object linking relevant documents and objects.

4. A dispute management system as in claim 3, wherein said dispute case object supports a plurality of interaction channels.

5. A dispute management system as in claim 3, wherein said dispute case object provides action log and note capabilities.

6. A dispute management system as in claim 3, wherein said dispute case object can be processed between a plurality of employees and across a plurality of departments.

7. A dispute management system as in claim 1, wherein said dispute case creator is capable of creating a dispute case automatically upon receiving information from said accounting system indicating an underpayment.

8. A dispute management system as in claim 1, wherein said dispute case creator is accessible to a customer for use to create said dispute case.

9. A dispute management system as in claim 1, wherein said dispute management system permits a user to split an open disputed item from undisputed items and initiate said split in said accounts receivable system.

10. A dispute management system as in claim 1, wherein said dispute management system provides access to at least one script, said script being useful for a user to read while communicating with said customer regarding said billing dispute.

11. A dispute management system as in claim 10, wherein said at least one script is offered to said user in a list form, permitting said user to select one script from said list to be displayed.

12. A dispute management system as in claim 1, wherein said dispute management system provides access to a scratch pad, said scratch pad being capable of being used by said user to take notes during a communication with said customer, wherein said dispute case creator can capture said notes in said dispute case.

13. A dispute management system as in claim 12, wherein said scratch pad being further usable after said dispute case is created for taking additional notes and said dispute case creator can capture said additional notes in said dispute case.

14. A dispute management system as in claim 1, further comprising a follow-up action trigger, said follow-up action trigger triggering events relating to said dispute case.

15. A dispute management system as in claim 14, wherein said follow-up action trigger can facilitate creation of a communication to said customer relating to said dispute case, a credit note, and a write-off.

16. A method of managing a billing dispute between a customer and a provider comprising the steps of:
searching for information relating to said customer and an account of said customer;
providing said information to a user for review;
creating a dispute case for said billing dispute, said dispute case organizing information related to said billing dispute; and
making said dispute case retrievable from an inbox.

17. A method of managing a billing dispute as in claim 16, wherein said searching step comprises searching for an account and searching for a disputed invoice.

18. A method of managing a billing dispute as in claim 17, further comprising the step of splitting a disputed item from undisputed items in said disputed invoice.

19. A method of managing a billing dispute as in claim 16, wherein said creating a dispute case step comprises capturing information relating to said dispute.

20. A method of managing a billing dispute as in claim 19, wherein said capturing information step comprises linking information to said dispute case or importing information into said dispute case.

21. A method of managing a billing dispute as in claim 19, wherein said creating a dispute case step comprises capturing information relating to a communication between said user and said customer regarding said dispute.

22. A method of managing a billing dispute as in claim 16, further comprising the step of creating an outgoing communication relating to said dispute, said outgoing communication being created through the selection of at least one text template from a list by said user.

23. A method of managing a billing dispute as in claim 16, further comprising the step of reversing a dunning fee.

24. A method of managing a billing dispute as in claim 23, wherein said reversing a dunning fee step comprises issuing a credit to a billing system.

25. A method of managing a billing dispute as in claim 23, wherein said reversing a dunning fee step comprises communicating with an accounts receivable system that said dunning fee need not be paid by said customer.

26. A method of managing a billing dispute as in claim 16, wherein said method is automatically initiated upon receipt of an underpayment by said customer.

27. A method of managing a billing dispute as in claim 16, wherein said method may be initiated by either said customer or said provider.
